(19) United States
(12) Patent Application Publication
(10) Pub. No.: US 2026/0103933 A1
(43) Pub. Date: Apr. 16, 2026

(54) MACHINE LEARNING (ML) MODEL BASED PINCH-DETECTION FROM TIME-SERIES DATA OF MOTOR ASSOCIATED WITH VEHICLE MOVABLE GATE

(71) Applicant: Honda Motor Co., Ltd., Tokyo (JP)

(72) Inventors: AMITKUMAR B PATIL, MARYSVILLE, OH (US); ALEC S. DRAUGHON, HILLIARD, OH (US)

(21) Appl. No.: 18/912,214

(22) Filed: Oct. 10, 2024

(51) Int. Cl. E05F 15/40; E05F 15/659; E05F 15/79; G06N 3/0464

(52) U.S. Cl. CPC E05F 15/40; E05F 15/659; E05F 15/79; G06N 3/0464; E05Y 2400/30; E05Y 2400/54; E05Y 2900/532; E05Y 2900/536; E05Y 2900/542; E05Y 2900/544; E05Y 2900/546; E05Y 2900/548

(57) ABSTRACT

An electronic device and a method for machine learning model based pinch detection from time-series data of a motor associated with a vehicle movable gate of a vehicle are provided. The electronic device comprises a control circuitry. The control circuitry acquires time-series data associated with an operation of the motor. The control circuitry determines statistical features associated with the acquired time-series data. The control circuitry acquires sensor data associated with a set of sensors. The control circuitry applies a machine learning (ML) model on the acquired time-series data and the sensor data. The ML model may be trained based on the determined statistical features. The control circuitry determines a type of pinch corresponding to the movable gate of the vehicle, based on the application of the ML model. The control circuitry controls the operation of the motor based on the determined type of pinch.

### BACKGROUND

Power-operated vehicle gates, such as tailgates, liftgates, and doors, have become increasingly common in modern vehicles, offering convenience and improved accessibility for users. These systems typically employ motors to control the opening and closing of the gate, along with sensors to detect obstacles and prevent pinching or crushing of objects or body parts. Conventional pinch detection systems often rely on calibrated reference values of motor current or RPM to identify potential obstructions. These systems are typically calibrated for each specific vehicle model and are influenced by various factors such as seals, stoppers, and lock mechanisms. However, existing pinch detection methods face several challenges. Setting appropriate reference values to distinguish between typical variations in resistance from seals and stoppers and actual pinch events can be difficult and time-consuming. Additionally, these reference values often need to be recalibrated for each new vehicle model or trim level, leading to increased development time and costs. Furthermore, the accuracy of these systems can be affected by environmental factors such as temperature and vehicle orientation, potentially resulting in false detections or missed pinch events. These limitations highlight the need for more adaptive and robust pinch detection solutions that can improve safety, reduce false alarms, and streamline the implementation process across different vehicle models..

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a vehicle is provided. The vehicle may include a movable gate, a motor, a set of sensors associated with the vehicle, and a control circuitry. The motor may be configured to control an operation of the movable gate of the vehicle. The control circuitry may be coupled to the motor, and may acquire time-series data associated with an operation of the motor. The control circuitry may further determine statistical features associated with the acquired time-series data. The control circuitry may further acquire sensor data associated with the set of sensors. The control circuitry may further apply a machine learning (ML) model on the acquired time-series data and the sensor data. The ML model is trained based on the determined statistical features. The control circuitry may further determine a type of pinch corresponding to the movable gate of the vehicle, based on the application of the ML model. The control circuitry may further control the operation of the motor based on the determined type of pinch.

According to another embodiment of the disclosure, an electronic device is provided. The electronic device may include the control circuitry. The control circuitry may be coupled to the motor and configured to control the operation associated with the movable gate of a vehicle. The control circuitry may acquire the time-series data associated with the operation of the motor. The control circuitry may further determine the statistical features associated with the acquired time-series data. The control circuitry may further acquire the sensor data associated with the set of sensors of the vehicle. The control circuitry may further apply the ML model on the acquired time-series data and the sensor data. The ML model is trained based on the determined statistical features. The control circuitry may determine the type of pinch corresponding to the movable gate of the vehicle, based on the application of the ML model. The control circuitry may further control the operation of the motor based on the determined type of pinch.

According to another embodiment of the disclosure, a method in the vehicle is provided. The vehicle may include the motor configured to control the operation associated with the movable gate of the vehicle. The method may include acquisition of the time-series data associated with the operation of the motor. The method may further include determination of the statistical features associated with the acquired time-series data. The method may further include acquisition of the sensor data associated with the set of sensors of the vehicle. The method may further include application of the ML model on the acquired time-series data and the sensor data. The ML model may be trained based on the determined statistical features. The method may further include determination of the type of pinch corresponding to the movable gate of the vehicle, based on the application of the ML model. The method may further include initiating control of the operation of the motor based on the determined type of pinch.

### BRIEF DESCRIPTION OF THE DRAWINGS

FIG. 1 is a block diagram that illustrates an exemplary network environment for machine learning model based pinch detection from time-series data of a motor associated with a vehicle movable gate, in accordance with an embodiment of the disclosure.

FIG. 2 is a block diagram that illustrates an exemplary electronic device of FIG. 1, in accordance with an embodiment of the disclosure.

FIG. 3 is a block diagram that illustrates an exemplary vehicle of FIG. 1, in accordance with an embodiment of the disclosure.

FIG. 4 is a diagram that illustrates an execution pipeline for machine learning model based pinch detection from time-series data of a motor associated with a vehicle movable gate, in accordance with an embodiment of the disclosure.

FIG. 5A is a block diagram that illustrates exemplary scenario for machine learning model based feature extraction from sensor data to detect the pinch or unwanted objects, in accordance with one embodiment of the disclosure.

FIG. 5B is a block diagram that illustrates exemplary scenario for deployment of the machine learning model embedded into a tail gate control unit, in accordance with another embodiment of the disclosure.

FIG. 6 is a block diagram that illustrates an exemplary scenario of adjustment of operational speed of a motor of a vehicle movable door of a vehicle and a pinch force associated with a vehicle body of the vehicle, in accordance with an embodiment of the disclosure.

FIG. 7 is a diagram that illustrates graphical representation of motor current data sample, in accordance with an embodiment of the disclosure.

FIG. 8 is a flowchart that illustrates exemplary operations of a method for machine learning model based pinch detection from time-series data of a motor associated with a vehicle movable gate, in accordance with another embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed electronic device and a method for machine learning model based pinch detection from time-series data of motor associated with vehicle movable gate. Exemplary aspects of the disclosure provide an electronic device that may comprise a control circuitry. The control circuitry may be coupled to the motor and configured to control an operation associated with the movable gate of the vehicle. The control circuitry may be further configured to acquire the time-series data associated with an operation of the motor. The control circuitry may be further configured to determine statistical features associated with the acquired time-series data. The control circuitry may be further configured to acquire sensor data associated with a set of sensors of the vehicle. The control circuitry may be further configured to apply a machine learning (ML) model on the acquired time-series data and the sensor data. The ML model may be trained based on the determined statistical features. The control circuitry may be further configured to determine a type of pinch corresponding to the movable gate of the vehicle, based on the application of the ML model. The control circuitry may be further configured to control the operation of the motor based on the determined type of pinch.

Traditional pinch detection models may often depend on a reference value of motor current or motor RPM to detect pinch condition, which can lead to failure in detection of other types of pinch condition. Typically, the failure in detection of the type of pinch condition may be due to seals, stoppers, lock mechanism and kinematics of the tailgate, inability to distinguish variation of the seals and stoppers from actual unwanted pinch, and continuous need to set the reference values for new vehicle model and vehicle trims. The present disclosure provides an electronic device and a method designed to enhance the efficiency of pinch condition detection as well as pinch type determination, based on the application of the ML model. The electronic device of the disclosure may employ a network of diverse vehicles, each equipped with a Gate Control Unit (GCU) or a compatible phone application, to facilitate communication with a centralized server, based on the application of the ML model. The ML model may play a central role in efficiently detecting the pinch condition and determining pinch condition type, taking into account the time-series data associated with an operation of the motor and the sensor data associated with the set of sensors. In contrast to the traditional pinch detection models, the disclosed pinch condition detection and the disclosed pinch type determination based on the application of the ML model may lead to effective classification of the unwanted pinch and typical resistance. The disclosed method for pinch condition and type determination may be robust from the objections caused due to vehicle seals and stoppers. Further, the disclosed method may lead to a reduced false detection rate, an enhanced ability to detect other types of pinch condition due to seals, stoppers, lock mechanism and kinematics of the tailgate, which may eliminate the continuous need to set the reference values for new vehicle model and vehicle trims.

The disclosed electronic device may be equipped with the control circuitry that may perform several functions to streamline the pinch condition detection process as well as pinch type determination process. The control circuitry may acquire the time-series data associated with the operation of the motor. The time-series data may include a current associated with the motor, and a rotation speed associated with the motor. Based on the acquired time-series data, the statistical features associated with the time-series data may be determined. The disclosed electronic device may also gather the sensor data associated with the set of sensors, wherein the sensor data including at least one of an orientation of the vehicle, a temperature of the vehicle, or a battery voltage of the vehicle. The ML model may then be applied to the time-series data and the sensor data, to determine the type of pinch corresponding to the movable gate of the vehicle. The disclosed electronic device may then control the operation of the motor based on the determined type of pinch, thereby efficiently reducing the false detection rate.

The disclosed electronic device may allow for determination of the pinch condition and the type of pinch on a real-time basis, ensuring smooth operation of the motor based on the determined pinch type. By considering factors such as the time-series data, the sensor data, and the statistical features associated with the time-series data and the application of the ML model, the disclosed method may not need to continuously set the reference values for new vehicle model and vehicle trims. Additionally, the provision of design flexibility to use different types of seals and stopper mechanism may encourage elimination of the false detection rate due to part variation, which can further lead to cost optimization associated with the detection of the pinch condition and the determination of the pinch condition type. Overall, the disclosed electronic device may provide a substantial improvement over conventional pinch detection methods, offering a more adaptable, efficient, and accurate approach to the pinch condition detection and the pinch condition determination.

Reference will now be made in detail to specific aspects or features, examples of which are illustrated in the accompanying drawings. Wherever possible, corresponding or similar reference numbers will be used throughout the drawings to refer to the same or corresponding parts.

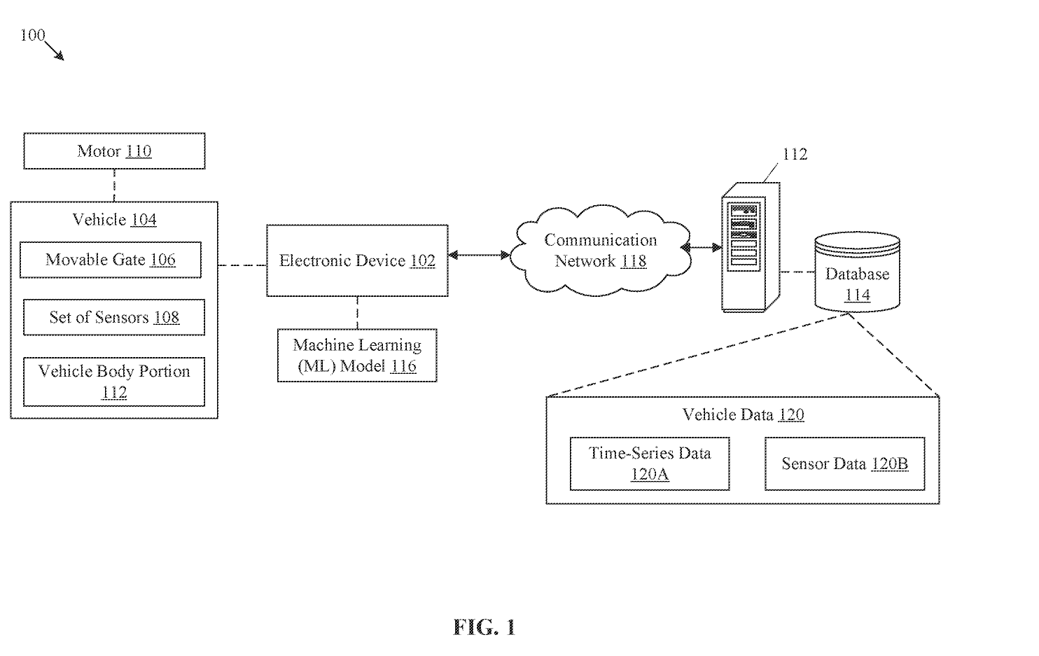

FIG. 1 is a block diagram that illustrates an exemplary network environment for machine learning model based pinch detection from time-series data of a motor associated with a vehicle movable gate, in accordance with an embodiment of the disclosure. With reference to FIG. 1, there is shown a network environment 100. The network environment 100 may include an electronic device 102, a vehicle 104, a server 112, a database 114, and a communication network 118. The electronic device 102 may include a machine learning (ML) model 116. The electronic device 102, the vehicle 104, the server 112, and the database 114 may be communicatively coupled to each other via the communication network 118. A motor 110 may be associated with a movable gate 106 of the vehicle 104. The vehicle 104 may further include a set of sensors 108 and a vehicle body portion 122. In FIG. 1, there is further shown vehicle data 120 that may be stored in the database 114. Further, the vehicle data 120 stored in the database 114 may include information such as time-series data 120A and sensor data 120B. The time-series data 120A may be associated with an operation of the motor 110, and the sensor data 120B may be associated with measurements of the set of sensors 108. Though the vehicle 104 in FIG. 1 has been shown to include only one vehicle, the scope of the disclosure may not be so limited. The vehicle 104 may include one vehicle or more than one vehicles, without departing from the spirit of the disclosure.

The electronic device 102 may include suitable logic, control circuitry, interfaces, and/or code that may be configured to acquire the time-series data 120A associated with the operation of the motor 110. The electronic device 102 may be communicatively coupled with the vehicle 104 and the motor 110. Further, the electronic device 102 may determine the statistical features associated with the acquired time-series data 120A. Further, the electronic device 102 may acquire the sensor data 120B associated with the set of sensors 108. Further, the electronic device 102 may apply the ML model 116 on the acquired time-series data 120A and the sensor data 120B. The ML model 116 may be trained based on the determined statistical features. Further, the electronic device 102 may determine a type of pinch corresponding to the movable gate 106 of the vehicle 104, based on the application of the ML model 116. Further, the electronic device 102 may control the operation of the motor 110 based on the determined type of pinch.

Examples of the electronic device 102 may include, but are not limited to, a computing device, a smartphone, a cellular phone, a mobile phone, a computer work-station, a consumer electronic (CE) device, a vehicle remote controller device, a user wearable device, and/or any computing device that may be capable to remotely control the vehicles 104. In an embodiment, the electronic device 102 may be associated with at least one of a vehicle manufacturer, a vehicle dealer, a vehicle vendor, a service provider, an infrastructure provider, or the driver associated with the vehicle 104.

The vehicle 104 may include suitable logic, control circuitry, interfaces, and/or code that may be configured to acquire the time-series data 120A associated with the operation of the motor 110. Further, the vehicle 104 may determine the statistical features associated with the acquired time-series data 120A. The vehicle 104 may acquire the sensor data 120B associated with the set of sensors 108. Further, the vehicle 104 may apply the ML model 116 on the acquired time-series data 120A and the sensor data 120B. The ML model 116 may be trained based on the determined statistical features. The determined statistical features may include at least one of a mean, a standard deviation, a skewness, a kurtosis, a variance, Fast Fourier Transform (FFT) coefficients, or a data length associated with the acquired time-series data 120A. Further, the vehicle 104 may determine the type of pinch corresponding to the movable gate 106 of the vehicle 104, based on the application of the ML model 116. The vehicle 104 may control the operation of the motor 110 based on the determined type of pinch. The determined type of pinch may correspond to an angle between a position of the movable gate 106 and the vehicle body portion 122 associated with the movable gate 106. The movable gate 106 may correspond to at least one of a door of the vehicle 104, a tailgate of the vehicle 104, a liftgate of a vehicle 104, a window of the vehicle 104, a bonnet of the vehicle 104, a sunroof of the vehicle 104, or a trunk of the vehicle 104. The set of sensors 108 may include a speed sensor, a current sensor, a voltage sensor, or any other sensors. The speed sensor may detect the rotation speed associated with the motor 110. The speed sensor may be any type of speed sensor appropriate for monitoring the rotation speed of the motor 110, such as an encoder, Hall effect sensor, or other type of sensor. In an embodiment, the speed sensor may send an output to a motor regulator (not shown) to control the rotation speed of the motor 110. The current sensor may measure the current associated with the motor 110. The voltage sensor may measure the voltage across the motor 110 and send information related to the measured voltage to the motor regulator as well. The voltage sensor may further send its output to a force calculator (not shown) of the electronic device 102, to calculate motor force.

The vehicle 104 may be a non-autonomous vehicle, a semi-autonomous vehicle, or a fully autonomous vehicle. Examples of the vehicle 104 may include, but are not limited to, a two-wheeler vehicle, a three-wheeler vehicle, a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell based car, a solar powered-car, or a hybrid car. The present disclosure may be also applicable to other types of two-wheelers (e.g., a scooter) or four-wheelers. The description of other types of vehicles has been omitted from the disclosure for the sake of brevity. Each vehicle may be registered to a corresponding owner based on vehicle identification information associated with the corresponding vehicle.

The motor 110 may be configured to control the operation of the movable gate of the vehicle 104. The motor 110 may be actuatable by the motor actuator, such as a bi-directional relay, H-bridge power transistor or other actuation device. The motor actuator may connect and disconnect the motor 110 to and from a power source.

The server 112 may include suitable logic, control circuitry, and interfaces, and/or code that may be configured to receive the acquire the time-series data 120A associated with the operation of the motor 110. The server 112 may determine the statistical features associated with the acquired time-series data 120A. The server 112 may acquire the sensor data 120B associated with the set of sensors 108. The server 112 may apply the ML model 116 on the acquired time-series data 120A and the sensor data 120B. The ML model 116 may be trained based on the determined statistical features. The server 112 may determine the type of pinch corresponding to the movable gate 106 of the vehicle 104, based on the application of the ML model 116. The server 112 may control the operation of the motor 110 based on the determined type of pinch.

The server 112 may be implemented as a cloud server and may execute operations through web applications, cloud applications, HTTP requests, repository operations, file transfer, and the like. Other example implementations of the server 112 may include, but are not limited to, a database server, a file server, a web server, a media server, an application server, a mainframe server, or a cloud computing server.

In at least one embodiment, the server 112 may be implemented as a plurality of distributed cloud-based resources by use of several technologies that are well known to those ordinarily skilled in the art. A person with ordinary skill in the art will understand that the scope of the disclosure may not be limited to the implementation of the server 112 and the electronic device 102 as two separate entities. In certain embodiments, the functionalities of the server 112 can be incorporated in its entirety or at least partially in the electronic device 102, without a departure from the scope of the disclosure.

The database 114 may include suitable logic, interfaces, and/or code that may be configured to store information related to the vehicle data 120, time-series data 120A, the sensor data 120B. In an example, the database 114 may store the time-series data 120A and the sensor data 120B. The time-series data 120A may include at least one of the current associated with the motor 110, or the rotation speed associated with the motor 110. The sensor data 120B may include at least one of the orientation of the vehicle 104, the temperature of the vehicle 104, or the battery voltage of the vehicle 104. The database 114 may be derived from data off a relational or non-relational database, or a set of comma-separated values (csv) files in conventional or big-data storage. The database 114 may be stored or cached on a device, such as a server (e.g., the server 112) or the electronic device 102. The device storing the database 114 may be configured to receive a query for the acquisition of the time-series data 120A associated with the operation of the motor 110. In response, the device of the database 114 may be configured to retrieve and provide the queried time-series data 120A associated with the operation of the motor 110 to the server 112 and/or the electronic device 102 based on the received query. In some embodiments, the device storing the database 114 may receive a query for the sensor data 120B (or a part thereof). In response to such a request, the device of the database 114 may retrieve and provide the queried sensor data 120B (or the part thereof) to the server 112 and/or the electronic device 102.

In some embodiments, the database 114 may be hosted on a plurality of servers stored at same or different locations. The operations of the database 114 may be executed using hardware including a processor, a microprocessor (e.g., to perform or control performance of one or more operations), a field-programmable gate array (FPGA), or an application-specific integrated circuit (ASIC). In some other instances, the database 114 may be implemented using software.

The ML model 116 may be applied on the acquired time-series data 120A and the sensor data 120B. Further, the ML model 116 may be trained based on the determined statistical features. The ML model 116 may correspond to a convolution neural network model (CNN). The CNN may be a computational network or a system of artificial neurons, arranged in a plurality of layers, as nodes that may be configured to acquire the time-series data 120A associated with the operation of the motor 110 (and/or the sensor data 120B). The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the ML model 116 may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different mathematical function.

In training of the ML model 116, one or more parameters of each node of the neural network may be updated based on whether an output of the final layer for a given input (from the training dataset) matches a correct result based on a loss function for the neural network. The above process may be repeated for same or a different input until a minima of loss function may be achieved and a training error may be minimized. Several methods for training are known in art, for example, gradient descent, stochastic gradient descent, batch gradient descent, gradient boost, meta-heuristics, and the like.

In an embodiment, the ML model 116 may be a scalable deep-learning model comprising an encoder model, a decoder model, and a set of convolution neural network layers. The scalable deep-learning model may take un-processed data such as, an unprocessed time-series data 120A, to determine the statistical features associated with the unprocessed time-series data 120A. The encoder model of the present disclosure may receive the time-series data 120A as an input. Based on the received input, the encoder model may determine a compressed feature vector associated with the time-series data 120A and the sensor data 120B. An encoded version (i.e., the compressed feature vector) of the received time-series data 120A and the sensor data 120B as the input may be transmitted to the decoder model. The decoder model may reconstruct the input dataset such as, the received time-series data 120A and the sensor data 120B, back from the encoded version. Thus, the decoder model may decompress the compressed feature vector associated with the time-series data 120A and the sensor data 120B. Each of the set of convolution neural network layers may perform a dot product between two matrices. Herein, a first matrix also known as a kernel, may include a set of learnable parameters and a second matrix may be a portion of a receptive field associated with the corresponding convolution neural network layer. In an embodiment, a kernel size associated with each of the set of convolution neural network layers may be even. That is, the kernel size may be “2”, “4”, “6”, “8”, and so on.

In an embodiment, the ML model 116 may be the scalable deep-learning model. The ML model 116 may be trained to identify a relationship between inputs, such as, features in a training dataset, and output labels, such as, the determined statistical features and the determined type of pinch. The ML model 116 may be defined by its hyper-parameters, for example, number of weights, cost function, input size, number of layers, and the like. The parameters of the ML model 116 may be tuned and weights may be updated so as to move towards a global minima of a cost function for the ML model 116. After several epochs of the training on the feature information in the training dataset, the ML model may be trained to output the type of pinch from or for the time-series data 120A and the sensor data 120B, corresponding to the movable gate 106 of the vehicle 104.

The ML model 116 may include electronic data, which may be implemented as, for example, a software component of an application executable on the electronic device 102. The ML model 116 may rely on libraries, external scripts, or other logic/instructions for execution by a processing device. The ML model 116 may include code and routines configured to enable a computing device, such as the electronic device 102 to perform one or more operations such as, the acquisition of the time-series data 120A and the sensor data 120B, determination of the statistical features, and determination of the type of pinch. Additionally or alternatively, the ML model 116 may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 116 may be implemented using a combination of hardware and software.

The communication network 118 may include a communication medium through which the electronic device 102, the vehicle 104, the server 112, and the database 114 may communicate with each other. The communication network 118 may be one of a wired connection or a wireless connection. Examples of the communication network 118 may include, but are not limited to, the Internet, a cloud network, Cellular or Wireless Mobile Network (such as Long-Term Evolution and 5G New Radio), satellite network (e.g., a network of a set of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 118 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In an embodiment, the vehicle data 120 may be associated with the vehicle 104, or a corresponding vehicle of the set of vehicles. The vehicle data 120 may include the time-series data 120A and the sensor data 120B. The time-series data 120A may include information related to at least one of the current associated with the motor 110, or the rotation speed associated with the motor 110. The sensor data 120B may include information related to at least one of the orientation of the vehicle 104, the temperature of the vehicle 104, or the battery voltage of the vehicle 104.

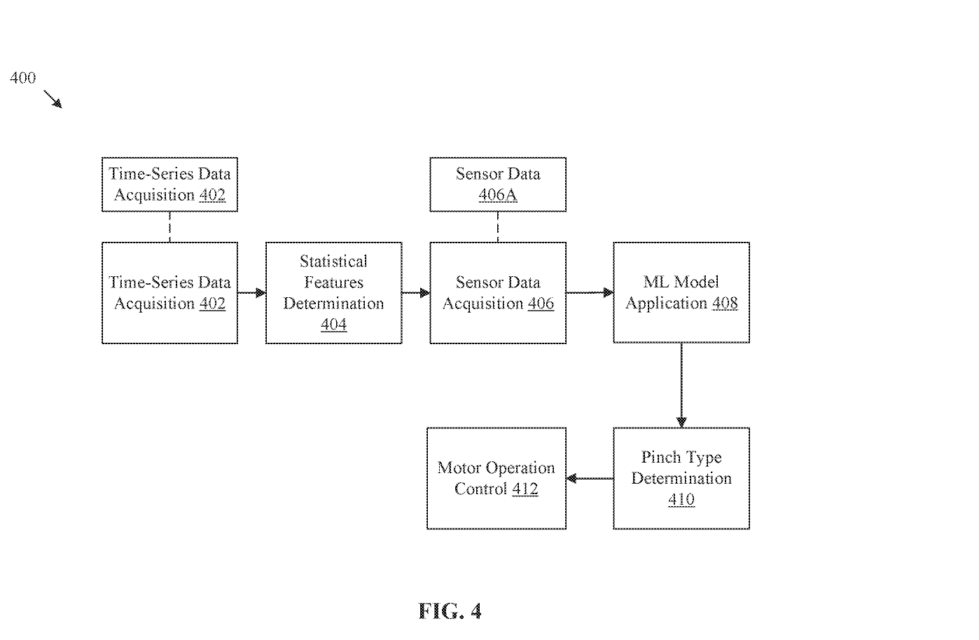

In operation, the electronic device 102 may acquire the time-series data 120A associated with the operation of the motor 110. In an embodiment, the motor 110 may be configured to control the operation of the movable gate 106 of the vehicle 104. Details related to the acquisition of the time-series data 120A are further provided, for example, in FIG. 4 (at 402).

The electronic device 102 may determine the statistical features associated with the acquired time-series data 402A. For example, the determined statistical features may include at least one of, but not limited to, a mean, a standard deviation, a skewness, a kurtosis, a variance, Fast Fourier Transform (FFT) coefficients, or a data length associated with the acquired time-series data 120A. Details related to the determination of the statistical features are further provided, for example, in FIG. 4 (at 404).

The electronic device 102 may acquire the sensor data 120B associated with the set of sensors 108. The sensor data 120B may include information related to at least one of, but not limited to, the orientation of the vehicle 104, the temperature of the vehicle 104, or the battery voltage of the vehicle 104. Details related to the acquisition of the sensor data 120B associated with the set of sensors 108 are further provided, for example, in FIG. 4 (at 406). The electronic device 102 may apply the ML model 116 on the acquired time-series data 120A and the sensor data 120B. The ML model 116 may be trained based on the determined statistical features. Details related to the application of the ML model are further provided, for example, in FIG. 4 (at 408).

The electronic device 102 may determine a type of pinch corresponding to the movable gate 106 of the vehicle 104, based on the application of the ML model 116. For example, the type of pinch may correspond to an angle between a position of the movable gate 106 and the vehicle body portion 122 associated with the movable gate 106. Details related to the determination of the type of pinch corresponding to the movable gate 106 of the vehicle are further provided, for example, in FIG. 4 (at 410). The electronic device 102 may control the operation of the motor 110 based on the determined type of pinch. Details related to the control of the operation of the motor are further provided, for example, in FIG. 4 (at 412).

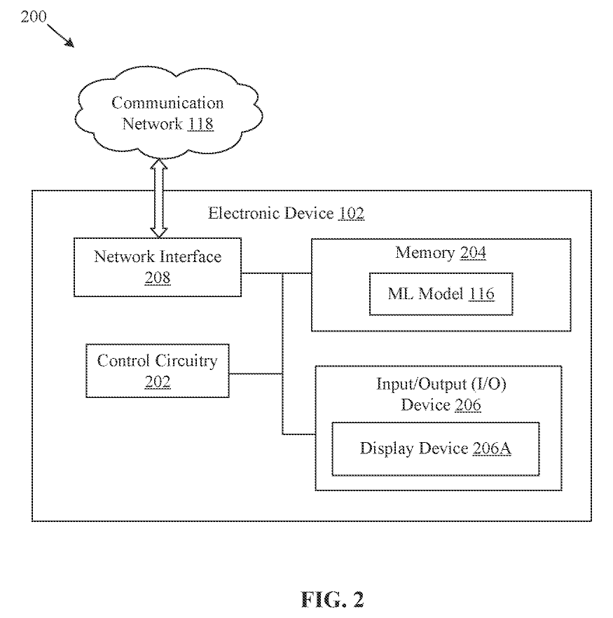

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown a block diagram 200 of the electronic device 102. The electronic device 102 may include a control circuitry 202, a memory 204, an input/output (I/O) device 206, and a network interface 208. The input/output device 206 may include a display device 206A. Although in FIG. 2, it is shown that the electronic device 102 includes the control circuitry 202, the memory 204, the I/O device 206, and the network interface 208; however, the disclosure may not be so limiting, and the electronic device 102 may include less or more components to perform the same or other functions of the electronic device 102. Details of the other functions or components have been omitted from the disclosure for the sake of brevity.

The control circuitry 202 may include suitable logic circuitry and interfaces that may be configured to execute program instructions associated with different operations to be executed by the electronic device 102. For example, some of the operations may include time-series data acquisition, statistical features determination, sensor data acquisition, ML model application, type of pinch determination, and motor control operation. The control circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The control circuitry 202 may be implemented based on a number of processor technologies known in the art. Examples of implementations of the control circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, control circuitry, and interfaces that may be configured to store the one or more instructions to be executed by the control circuitry 202. The memory 204 may be configured to store the vehicle data 120 including the time-series data 120A , and the sensor data 120B. In an example, the memory 204 may also store the data related to the determined statistical features. Further, in an example, the memory 204 may store the data related with to the determined type of pinch. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, control circuitry, and interfaces that may be configured to receive the time-series data 120A and the sensor data 120B as an input and provide an output based on the received input. For example, the time-series data 120A and the sensor data 120B may be received, via the I/O device 206. Further, details related to the received time-series data, the determined statistical features, the received sensor data, the applied ML model, the determined type of pinch, and the controlled motor operation may be output, via the I/O device 206. The I/O device 206 which may include various input and output devices, may be configured to communicate with the electronic device 102 or the server 112. Examples of the I/O device 206 may include, but are not limited to, a touch screen, a keyboard, a mouse, a joystick, a microphone, a display device (e.g., the display device 206A), a haptic device, and a speaker.

The display device 206A may include suitable logic, control circuitry, and interfaces that may be configured to display the vehicle data 120 (including the acquired time-series data 120A and the acquired sensor data 120B), the determined statistical features, and the determined type of pinch. The display device 206A may be a touch screen which may enable the vehicle 104 to provide the vehicle data 120, via the display device 20A. The display device 206A may be a touch screen which may display the vehicle data 120 (including the acquired time-series data 120A and the acquired sensor data 120B), the determined statistical features, and the determined type of pinch. The touch screen may be at least one of a resistive touch screen, a capacitive touch screen, or a thermal touch screen. The display device 206A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 206A may refer to a display screen of a head mounted device (HMD), a smart-glass device, a see-through display, a projection-based display, an electro-chromic display, or a transparent display.

The network interface 208 may include suitable logic, control circuitry, and interfaces that may be configured to facilitate communication between the electronic device 102, the vehicle 104, the server 112, and the database 114, via the communication network 11. The network interface 208 may be implemented by use of various known technologies to support wired or wireless communication of the electronic device 102 with the communication network 118. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer control circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation New Radio (5G NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The functions or operations executed by the electronic device 102, as described in FIG. 1, may be performed by the control circuitry 202. Operations executed by the control circuitry 202 are described in detail, for example, in FIG. 4.

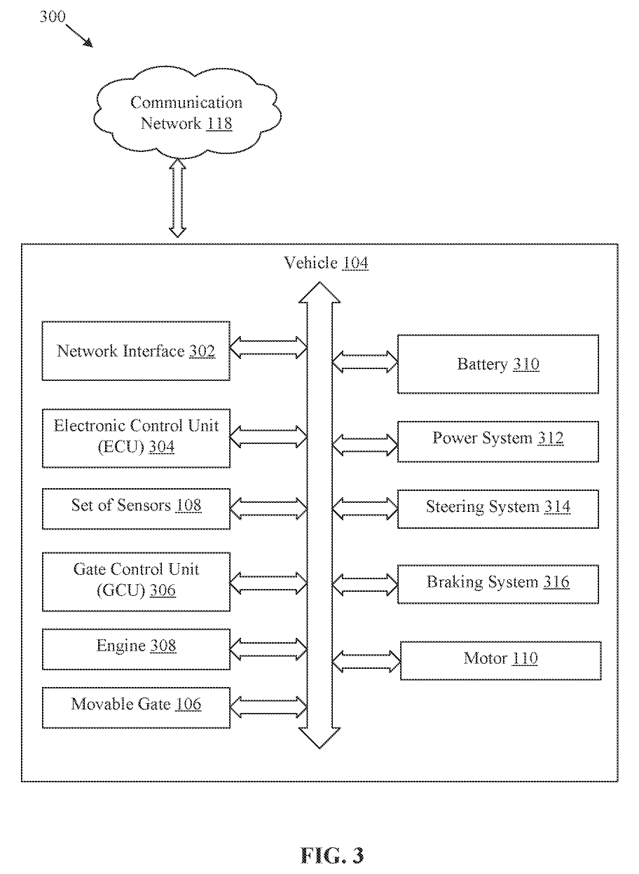

FIG. 3 is a block diagram that illustrates an exemplary vehicle of FIG. 1, in accordance with an embodiment of the disclosure. FIG. 3 is explained in conjunction with elements from FIG. 1 and FIG. 2. With reference to FIG. 3, there is shown a block diagram 300 of the vehicle 104. The vehicle 104 may include the movable gate 106, the set of sensors 108, the motor 110, a network interface 302, an electronic control unit (ECU) 304, a gate control unit (GCU) 306, an engine 308, a battery 310, a power system 312, a steering system 314, and a braking system 316. Although in FIG. 3, it is shown that the vehicle 104 includes the movable gate 106, the set of sensors 108, the motor 110, a network interface 302, an electronic control unit (ECU) 304, a gate control unit (GCU) 306, an engine 308, a battery 310, a power system 312, a steering system 314, and a braking system 316; however, the disclosure may not be so limiting, and the vehicle 104 may include less or more components to perform the same or other functions of the vehicle 104. Details of the other functions or components have been omitted from the disclosure for the sake of brevity.

The set of sensors 108 may include a speedometer, an accelerometer, a current sensor, a speed sensor, a voltage sensor, a location sensor, a tachometer, a weather sensor, an imaging sensor, a pressure sensor, a temperature sensor, a level sensor, a shock absorber, and the like. The speedometer may measure an instantaneous speed or an average speed of the vehicle 104 The accelerometer may measure an instantaneous acceleration or an average acceleration of the vehicle 104. The speed sensor may detect a rotation speed associated with the motor 110. The current sensor may measure a current associated with the motor 110. The voltage sensor may measure a voltage across the motor 110 and send information related to the measured voltage to the motor regulator as well. The location sensor may determine a location of the vehicle 104. The tachometer may determine a speed in rotations per minute of the engine 308 of the vehicle 104. The weather sensor may determine a weather of the location of the vehicle 104. The imaging sensor may capture images of a region around the vehicle 104. The pressure sensor may determine a pressure of fluids (for example, engine oil, transmission oil, and hydraulic oil) of the vehicle 104. The level sensor may determine a level of fluids of the vehicle 104. The temperature sensor may determine a temperature of a region around the vehicle 104.

The network interface 302 may include suitable logic, control circuitry, and interfaces that may be configured to facilitate communication between the electronic device 102, the vehicle 104, and the server 112, via the communication network 118. The network interface 302 may be implemented by use of various known technologies to support wired or wireless communication of the vehicle 104 with the communication network 118. The network interface 302 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer control circuitry. The network interface 302 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation New Radio (5G NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The electronic control unit (ECU) 304 may include suitable logic, control circuitry, interfaces, and/or code that may be configured to activate or deactivate the set of sensors 108 and the GCU 306. The electronic control unit 304 may be a specialized electronic control circuitry that may include an ECU processor to control different functions, such as, but not limited to, engine operations, communication operations, and data acquisition of the vehicle 104. In an embodiment, the electronic control unit 304 may be a microprocessor. Other examples of the electronic control unit 304 may include, but are not limited to, a vehicle control system, an in-vehicle infotainment (IVI) system, an in-car entertainment (ICE) system, an automotive Head-up Display (HUD), an automotive dashboard, an embedded device, a smartphone, a human-machine interface (HMI), a computer workstation, a handheld computer, a cellular/mobile phone, a portable consumer electronic (CE) device, a server, and other computing devices. The electronic control unit 304 may be included or integrated in the vehicle 104.

In an embodiment, the electronic control unit 304 may be a control circuitry that may be coupled to the motor 110, and configured to acquire the time-series data 120A associated with the operation of the motor 110. The control circuitry may be communicatively coupled with the vehicle 104 and the motor 110. The control circuitry may determine the statistical features associated with the acquired time-series data 120A. The control circuitry may acquire the sensor data 120B associated with the set of sensors 108. The control circuitry may apply the ML model 116 on the acquired time-series data 120A and the sensor data 120B. The ML model 116 may be trained based on the determined statistical features. The control circuitry 202 may determine the type of pinch corresponding to a movable gate 106 of the vehicle 104, based on the application of the ML model 116. The control circuitry may control the operation of the motor 110 based on the determined type of pinch.

The gate control unit (GCU) 306 may include suitable logic, control circuitry, interfaces, and/or code that may be configured to acquire the time-series data 120A associated with the operation of the motor 110. The control circuitry may be communicatively coupled with the vehicle 104 and the motor 110. The control circuitry may determine the statistical features associated with the acquired time-series data 120A. The control circuitry may acquire the sensor data 120B associated with the set of sensors 108. The control circuitry may apply the ML model 116 on the acquired time-series data 120A and the sensor data 120B. The ML model 116 may be trained based on the determined statistical features. The control circuitry 202 may determine the type of pinch corresponding to a movable gate 106 of the vehicle 104, based on the application of the ML model 116. The control circuitry may control the operation of the motor 110 based on the determined type of pinch.

The engine 308 may be configured to provide power to the vehicle 104. The engine 308 may be an internal combustion engine with may include operations, for example, fuel injection, compression, ignition, or emission to power and drive the vehicle 104. The engine 308 may include various parts, for example, but are not limited to, a crankshaft, a cylinder, a spark plug, a piston, camshaft, a valve, combustion chamber, etc. In some embodiments, the engine 308 may include a motor in case of an electric motorcycle. The engine 308 may be two-stroke or four-stroke internal combustion engines. The engine 308 may include either one, two, three, four, or six cylinders. Examples of the engine 308 may include, but are not limited to, an inline engine (i.e. single cylinder, parallel twin, inline-triple, inline-four, inline-six), a V layout engine (i.e. V-twin engine, a V4 engine, a V8 engine), a flat (boxer) engine (i.e. flat-two, flat-four, flat-six), a lawn mower engine, a snow blower engine, or other motorcycle engines known in the art. A description of various parts of the engine 308 has been omitted from the disclosure for the sake of brevity.

The battery 310 may be a source of electric power for one or more electric circuits or loads (not shown). For example, the battery 310 may be a source of electrical power to a control circuitry (not shown) of the vehicle 104, network interface 302, the electronic control unit 304, the engine 308, the power system 312, the steering system 314, and the braking system 316. The battery 310 may be a rechargeable battery. The battery 310 may be the source of electrical power to start the engine 308 of the vehicle 104. In some embodiments, the battery 310 may correspond to a battery pack, which may have a plurality of clusters of batteries, which may be surrounded by a suitable coolant and a charge controller (not shown in FIG. 3). Examples of the battery 310 may include, but are not limited to, a lead acid battery, a nickel cadmium battery, a nickel–metal hydride battery, a lithium-ion battery, and other rechargeable batteries.

The power system 312 may include suitable logic, control circuitry, interfaces, and/or code that may be configured to control electric power which may be output to various electric circuits and loads of the vehicle 104. The power system 312 may include a battery (not shown) to provide the electric power to perform various electrical operations of the vehicle 104. The power system 312 may provide the electric power for functioning of different components (such as, the set of sensors 108, the electronic control unit 304, a communication system, and the steering system 314) of the vehicle 104. The power system 312 may be configured to receive control signals from the processor to control the set of sensors 108, the electronic control unit 304, the communication system, and the steering system 314 of the vehicle 104. The power system 312 may be configured to control the charging and the discharging of the battery 310 and an auxiliary battery based on the received control signals. The power system 312 may be configured to control the transfer of the electric energy between the power system 312 and the set of sensors 108, the communication system, and the steering system 314 of the vehicle 104. Examples of the power system 312 may include, but are not limited to, an electric charge/discharge controller, a charge regulator, a battery regulator, a battery management system, an electric circuit breaker, a power electronic drive control system, an Application-Specific Integrated Circuit (ASIC) processor, and/or other energy-control hardware processors.

The steering system 314 may receive one or more control commands from a user. The steering system 314 may include a steering wheel/handlebar and/or an electric motor (provided for a power-assisted steering) that may be used by a driver to control movement of the vehicle 104 in manual mode or a semi-autonomous mode. In accordance with an embodiment, the movement or steering of the vehicle 104 may be automatically controlled when the vehicle 104 is in autonomous mode. Examples of the steering system 314 may include, but are not limited to, an autonomous steering control, a power-assisted steering system, a vacuum/hydraulic-based steering system, an electro-hydraulic power-assisted system (EHPAS), or a “steer-by-wire” system, or an autonomous steering system, known in the art.

The braking system 316 may be used to stop or slow down the vehicle 104 by application of resistive forces, such as electromagnetic and/or frictional forces. The braking system 316 may receive a command from a powertrain control system under the control of a control circuitry when the vehicle 104 is in an autonomous mode or a semi-autonomous mode. In accordance with an embodiment, the braking system 316 may receive a command from the control circuitry when the control circuitry preemptively detects intent of the driver to perform a specific task which requires the user to apply brakes.

FIG. 4 is a diagram that illustrates an execution pipeline for machine learning model based pinch detection from time-series data of a motor associated with a vehicle movable gate, in accordance with an embodiment of the disclosure. FIG. 4 is explained in conjunction with elements from FIG. 1, FIG. 2, and FIG. 3. With reference to FIG. 4, there is shown an execution pipeline 400 for machine learning model (e.g., the ML model 116) based pinch detection from time-series data (e.g., the time-series data 120A) of a motor (e.g., the motor 110) associated with a vehicle movable gate (e.g., the movable gate 106). The execution pipeline 400 includes exemplary operations from 402 to 412 that may be executed by the control circuitry 202 of the electronic device 102. In FIG. 4, there are further shown time-series data 402A and sensor data 406A.

At 402, an operation of time-series data acquisition may be executed. In an embodiment, the control circuitry 202 may be configured to acquire the time-series data 402A associated with the operation of the motor 110. The time-series data 402A may include at least one of the current associated with the motor 110, or the rotation speed associated with the motor 110. In an example, the time-series data 402A may be received from the electronic device 102, the vehicle 104, the server 112, and/or the database 114. The time-series data 402A may be motor current data with a plurality of datapoints for each stroke of a vehicle movable gate (e.g., the movable gate 106, such as, a vehicle tailgate). The plurality of datapoints may vary during each stroke of the vehicle movable gate. Further, the time-series data 402A may include a rotation speed associated with the motor 110. The rotation speed may be controlled by way of adjustment of current associated with the operation of the motor 110. The rotation speed may vary due to the variation with respect to the plurality of datapoints for each stroke of the vehicle tailgate.

At 404, an operation of statistical features determination may be executed. In an embodiment, the control circuitry 202 may be configured to determine the statistical features associated with the acquired time-series data 402A. In an embodiment, the statistical features may include at least one of the mean, a standard deviation, a skewness, a kurtosis, a variance, Fast Fourier Transform (FFT) coefficients, or a data length associated with the acquired time-series data 402A. The “mean” may refer to an average value computed as a result of the combination of values for each stroke of the vehicle tailgate. In an example, the “mean” may correspond to an arithmetic mean, a median, or a mode value associated with the acquired time-series data 402A. The “standard deviation” may correspond to a variation in values the plurality of datapoints for each stroke of the vehicle movable gate (e.g., the movable gate 106, such as, a vehicle tailgate). The “skewness” may correspond to a description of a shape of probability distribution with respect to the plurality of datapoints. The “skewness” may correspond to an asymmetry of a probability distribution of the plurality of datapoints. The “skewness” may indicate a direction and a degree to which data associated with each stroke of the vehicle movable gate deviates from a symmetrical distribution. For example, a distribution with zero skewness may be perfectly symmetrical, meaning the left and right sides of the distribution are mirror images. A positive skewness may indicate that the data has a tendency to have higher values. A negative skewness indicates that the data has a tendency towards lower values. The “kurtosis” may refer to distribution's peak and the weight of its tails. For example, the data may have high kurtosis with many outliers but still be symmetric and thus have zero skewness. On the other hand, the data may be skewed with either positive or negative skewness but has low kurtosis, indicating fewer extreme values. The “variance” may refer to a degree of spread of the data with respect to the mean or the average value of the data. The “FFT coefficients” may refer to frequency domain values corresponding to the plurality of datapoints for each stroke of the vehicle movable gate.

At 406, an operation of sensor data acquisition may be executed. In an embodiment, the control circuitry 202 may be configured to acquire the sensor data 406A associated with the set of sensors 108. The sensor data 406A may include at least one of the orientation of the vehicle 104, the temperature of the vehicle 104, or the battery voltage of the vehicle 104. It may be appreciated that the sensor data 120B may be received from the electronic device 102 or the vehicle 104. For example, the set of sensors 108 associated with the vehicle 104 may determine a sensor-reading associated with each corresponding sensor of the set of sensors 108. The control circuitry 202 may receive the determined sensor-reading associated with each corresponding sensor of the set of sensors 108, as the sensor data 406A. In another scenario, the determined sensor-readings may be sent to the database 114 by a control circuitry (e.g., the ECU 304, the GCU 306) of the vehicle 104. In such a case, the control circuitry 202 may receive the determined sensor-readings from the database 114, as the sensor data 406A.

At 408, an operation of ML model application may be executed. In an embodiment, the control circuitry 202 may be configured to apply the ML model 116 on the acquired time-series data 402A and the sensor data 406A. It may be appreciated that the ML model 116 may be trained based on the determined statistical features. The ML model 116 may correspond to the CNN model. The CNN may be the computational network or the system of artificial neurons, arranged in a plurality of layers, as nodes that may be configured to acquire the time-series data 402A associated with the operation of the motor 110. The acquired time-series data 402A and the sensor data 406A may be converted into input vectors and fed to the CNN model for inference of a type of pinch associated with the movable gate 106.

At 410, an operation of type of pinch determination may be executed. In an embodiment, the control circuitry 202 may be configured to determine the type of pinch corresponding to the movable gate 106 of the vehicle 104, based on the application of the ML model 116. The type of pinch may correspond to the angle between the position of the movable gate 106 of the vehicle 104 and the vehicle body portion 122 associated with the movable gate 106. For example, based on the application of the ML model 116, the control circuitry 202 may compare the acquired time-series data 402A with a first threshold range. The control circuitry 202 may then further determine the type of pinch based on the comparison of the acquired time-series data 402A.

In one example, the type of pinch may correspond to a no-type of pinch based on the acquired time-series data 402A being below the first threshold range. Further, the type of pinch may correspond to a small-type of pinch based on the acquired time-series data 402A being within the first threshold range. Further, the type of pinch may correspond to a large-type of pinch based on the acquired time-series data 402A being above the first threshold range.

In another example, based on the application of the ML model 116, the control circuitry 202 may be configured to compare the determined statistical features associated with the acquired time-series data 402A with a second threshold range. The control circuitry 202 may then further determine the type of pinch based on the comparison of the determined statistical features with the second threshold range.

In another example, the type of pinch may correspond to a no-type of pinch based on the acquired time-series data 402A being below the second threshold range. Further, the type of pinch may correspond to a small-type of pinch based on the acquired time-series data being within the second threshold range. Further, the type of pinch may correspond to a large-type of pinch based on the acquired time-series data being above the second threshold range.

At 412, an operation of motor operation control may be executed. In an embodiment, the control circuitry 202 may be configured to control the operation of the motor 110 based on the determined type of pinch. The time-series data 402A of the motor 110 may be controlled based on the determined type of pinch. For example, the current associated with the motor 110 and the rotation speed associated with the motor 110 may be controlled based on the determined type of pinch. As an example, in case, the type of pinch is determined as “no-pinch”, the control circuitry 202 may control the motor 110 to keep the RPM or the current of the motor 110 constant. In case of “small-pinch”, the control circuitry 202 may control the motor 110 to slightly vary the RPM or the current of the motor 110. Alternatively, in case of “large-pinch”, the control circuitry 202 may control the motor 110 to vary the RPM or the current of the motor 110 by a larger value. Accordingly, the operation of the motor 110 may be controlled such that a degree of pinch of the movable gate 106 is reduced.

Traditional pinch detection models may often depend on a reference value of motor current or motor RPM to detect pinch condition, which can lead to failure in detection of other types of pinch condition. Typically, the failure in detection of the type of pinch condition may be due to seals, stoppers, lock mechanism and kinematics of the tailgate, inability to distinguish variation of the seals and stoppers from actual unwanted pinch, and continuous need to set the reference values for new vehicle model and vehicle trims. The present disclosure provides an electronic device (e.g., the electronic device 102), a vehicle (e.g., the vehicle 104), and a method designed to enhance the efficiency of pinch condition detection as well as type of pinch determination, based on the application of an ML model (e.g., the ML model 116). The electronic device 102 of the disclosure may employ a network of diverse vehicles (e.g., the vehicle 104), each equipped with a Gate Control Unit (GCU) or a compatible phone application, to facilitate communication with a centralized server, based on the application of the ML model 116. The ML model 116 may play a central role in efficiently detecting the pinch condition and determining pinch condition type, taking into account the time-series data associated with an operation of the motor and the sensor data associated with the set of sensors. In contrast to the traditional pinch detection models, the disclosed pinch condition detection and the disclosed type of pinch determination based on the application of the ML model may lead to effective classification of the unwanted pinch and typical resistance. The disclosed method for pinch condition and type determination may be robust from the objections caused due to vehicle seals and stoppers. Further, the disclosed method may lead to a reduced false detection rate, an enhanced ability to detect other types of pinch condition due to seals, stoppers, lock mechanism and kinematics of the tailgate, which may eliminate the continuous need to set the reference values for new vehicle model and vehicle trims.

The disclosed electronic device 102 may be equipped with the control circuitry 202 that performs several functions to streamline the pinch detection and the type of pinch determination process. The control circuitry 202 may be coupled to the motor 110 and configured to control the operation associated with the movable gate 106 of the vehicle 104. In an example, the control circuitry 202 may be configured to acquire the time-series data 402A associated with the operation of the motor 110. The control circuitry 202 may then determine the statistical features associated with the acquired time-series data 402A. Upon determination of the statistical features, the control circuitry 202 may then acquire the sensor data 406A associated with the set of sensors 108 of the vehicle 104. Thereafter, the control circuitry 202 may apply the ML model 116 on the acquired time-series data 402A and the sensor data 406A. The ML model 116 may be trained based on the determined statistical features. Based on the application of the ML model 116, the control circuitry 202 may determine the type of pinch corresponding to the movable gate of the vehicle 104. The control circuitry 202 may then further control the operation of the motor 110 based on the determined type of pinch.

The disclosed electronic device 102 may allow for determination of the pinch condition and the type of pinch condition in real-time basis, ensuring smooth operation of the motor based on the determined pinch-type condition. By considering factors such as the time-series data, the sensor data, and the statistical features associated with the time-series data and the application of the ML model, the electronic device of the disclosure can completely eliminate the continuous need to set the reference values for new vehicle model and vehicle trims. Additionally, the provision of design flexibility to use different types of seals and stopper mechanism may encourage elimination of the false detection rate due to part variation, which can further lead to cost optimization associated with the detection of the pinch condition and the pinch condition type.

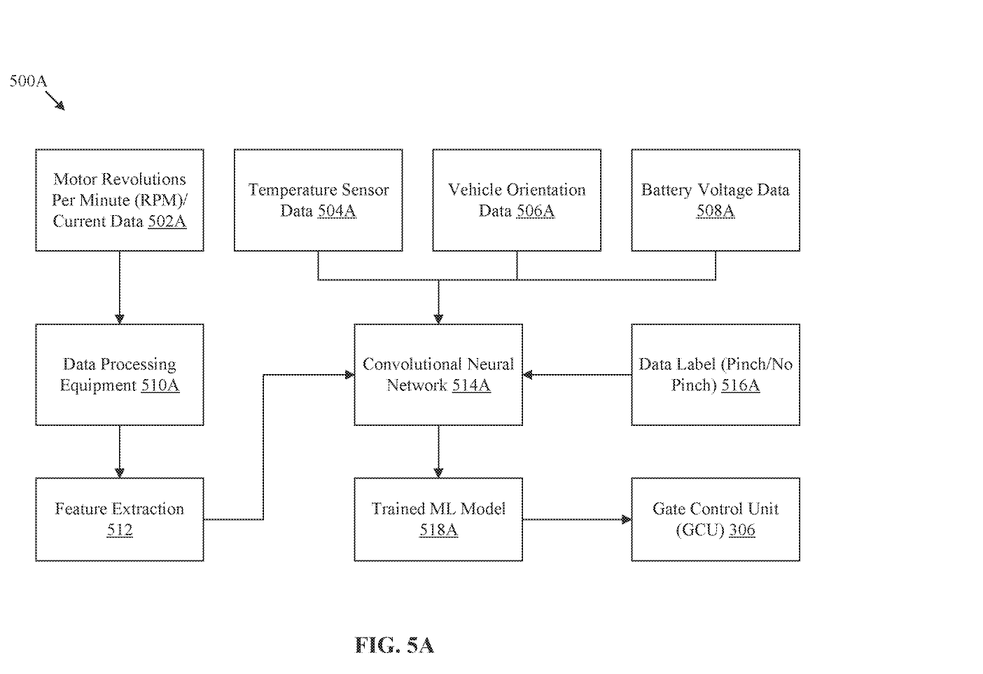

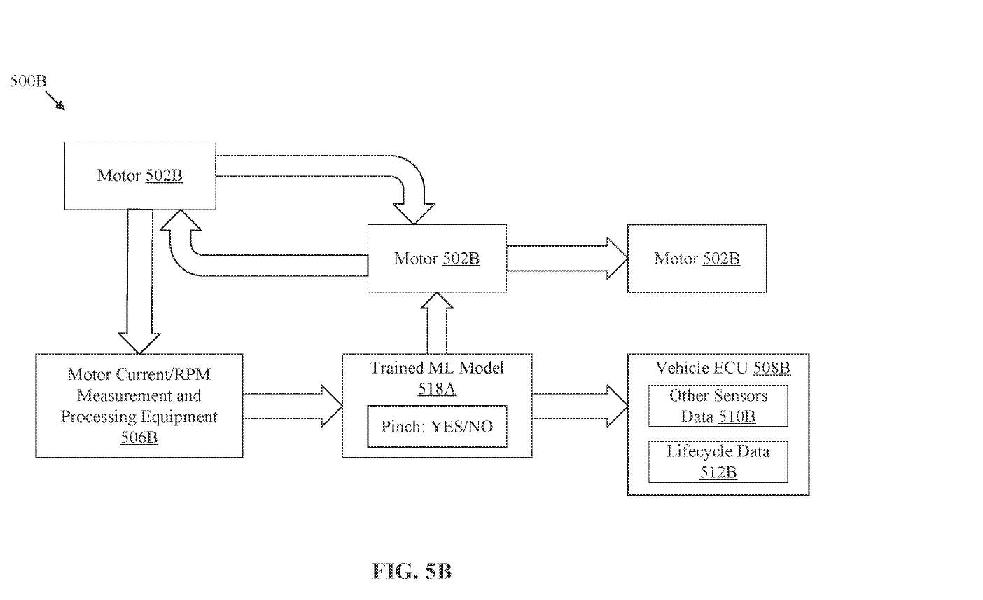

FIG. 5A is a block diagram that illustrates exemplary scenario for machine learning model based feature extraction from sensor data to detect the pinch or unwanted objects, in accordance with one embodiment of the disclosure. FIG. 5A is explained in conjunction with elements from FIG. 1, FIG. 2, FIG. 3, and FIG. 4. With reference to FIG. 5A, there is shown an exemplary scenario 500A for the machine learning model based pinch detection from the time-series data 120A of the motor 110 associated with a vehicle movable gate (e.g., the movable gate 106). The exemplary scenario 500A includes motor RPM/current data 502A, temperature sensor data 504A, vehicle orientation data 506A, battery voltage data 508A, a data processing equipment 510A, a feature extraction operation 512A, a CNN model 514A, a data label 516A, and a trained ML model 518A.

The motor RPM/current data 502A may be the time-series data 120A with the plurality of datapoints for each stroke of the vehicle tailgate (e.g., the movable gate 106). The plurality of datapoints may vary during each stroke of the vehicle tail gate (e.g., the movable gate 106). Further, the time-series data 402A may include information related to the rotation speed (the motor RPM) associated with the motor 110. The rotation speed may be controlled by way of adjustment of current associated with the operation of the motor 110. The rotation speed may vary due to the variation with respect to the plurality of datapoints for each stroke of the vehicle tailgate. The motor RPM/current data 502A may be similar to the time-series data 402A, and hence, further details about the motor RPM/current data 502A are omitted here for the sake of brevity.

In an example, the motor RPM/current data 502A may be determined by the GCU 306 of the vehicle 104 and transmitted to the control circuitry 202 of the electronic device 102. The motor RPM/current data 502A may refer to at least one of the current associated with the motor 110 or the rotation speed associated with the motor 110. Further, the electronic device 102 may display the operational rotation speed of the motor 110, and/or the value of the current at which the motor 110 is presently operating. The temperature sensor data 504A may be the temperature at which the motor 110 is operating. The vehicle orientation data 506A may be an angle or orientation between the movable gate 106 and the vehicle body portion 122 associated with the movable gate 106. Further, the vehicle orientation data 506A may be the angle between the movable gate 106 and the vehicle body portion 122, when the vehicle 104 moves, the vehicle 104 is being parked at a parking area, or the vehicle 104 is stationary. The battery voltage data 508A may be a measured battery voltage value corresponding to the operation of the motor 110. The battery voltage value may be measured by the voltage sensor across the motor 110, and the battery voltage value related to the operation of the motor 110 may be sent as output to the motor regulator as well. The voltage sensor may further send the output to the force calculator of the electronic device 102, to calculate the motor force.

In an example, the data processing equipment 510A may be controlled to process the time-series data 120A. The data processing equipment 510A may process the data related with the current associated with the motor 110, or process the data related with the rotation speed associated with the motor 110. It may be appreciated that the time-series data 120A may include at least one of the current associated with the motor 110 (the motor current data), or the rotation speed associated with the motor 110. For example, the motor current data may be the time-series data 120A through each stroke of a tailgate (e.g., the movable gate 106). The motor current data may not be directly fed to any artificial intelligence network, as each stroke of the tailgate may have the plurality of datapoints and length of the data may vary during each stroke of the tailgate, depending upon the temperature sensor data 504A, the vehicle orientation data 506A, and the battery voltage data 508A. The data processing equipment 510A may further process the data related to the first threshold range associated with the operation of the motor 110. The data processing equipment 510A may further process the data related to the second threshold range associated with the operation of the motor 110.

The control circuitry 202 of the electronic device 102 or the ECU 304 and/or the GCU 306 of the vehicle 104 may perform the function of feature extraction 512A, based on the processed time-series data. In an embodiment, the control circuitry 202 of the electronic device 102 or the vehicle 104 may display details related to the feature extraction 512A. The function of feature extraction 512A may correspond to the determination of the statistical features associated with the acquired time-series data 120A. For example, the control circuitry 202 may determine the statistical features associated with the acquired time-series data 120A. It may be appreciated that the statistical features associated with the acquired time-series data 120A may include at least one of the mean, the standard deviation, the skewness, the kurtosis, the variance, the Fast Fourier Transform (FFT) coefficients, or the data length associated with the acquired time-series data 120A.

In an example, the control circuitry 202 of the electronic device 102 may determine the type of pinch corresponding to the movable gate 106 of the vehicle 104, based on the application of the ML model 116. For example, the control circuitry 202 may utilize the determined statistical parameters along with other parameters to detect unwanted objects pinched with respect to the tailgate of the vehicle body portion 122, using the CNN model 514A. The detected unwanted objects pinched with respect to the tailgate of the vehicle body portion 122 may be labelled as the data label 516A. For instance, the data label 516A may represent the type of pinch as a “no-pinch” type based on the acquired time-series data 120A being below the first threshold range. Further, the data label 516A may represent the type of pinch as a “small-pinch” type based on the acquired time-series data 120A being within the first threshold range. Further, the data label 516A may represent the type of pinch as a “large-pinch” type based on the acquired time-series data 120A being above the first threshold range.

In another example, the control circuitry 202 of the electronic device 102 or the ECU 304 and/or the GCU 306 of the vehicle 104 may compare the determined statistical features associated with the acquired time-series data 120A with a second threshold range, to determine the data label 516A. For example, the data label 516A may represent the type of pinch as the “no-pinch” type based on the acquired time-series data 120A being below the second threshold range. Further, the data label 516A may represent the type of pinch as the “small-pinch” type based on the acquired time-series data 120A being within the second threshold range. Further, the data label 516A may represent the type of pinch as the “large-pinch” type based on the acquired time-series data 120A being above the second threshold range.

In an example, the type of pinch corresponding to the movable gate 106 of the vehicle 104 may be determined as the data label 516A, based on the application of the ML model 116. The ML model 116 may be the trained ML model 518A, which may be configured to be trained on a dataset associated with the determined statistical features. For example, the trained ML model 518A may be trained on the acquired time-series data 120A and the sensor data 120B. The trained ML model 518A may be further trained on the determined statistical features associated with the acquired time-series data 120A.

The trained ML model 518A may play a central role in efficiently detecting the pinch condition and determining pinch condition type, taking into account the time-series data 120A associated with an operation of the motor 110 and the sensor data 120B associated with the set of sensors 108. In contrast to the traditional pinch detection models, the disclosed pinch condition detection process and the pinch condition type determination process based on the application of the trained ML model 518A may lead to effective classification of the unwanted pinch and typical resistance due to the object from the vehicle seals and stoppers and the reduced false detection rate.

In an embodiment, the control circuitry 202 of the electronic device 102 or the ECU 304 or the GCU 306 of the vehicle 104 may control the operation of the motor 110 based on the determined type of pinch. It may be appreciated that the determined type of pinch may correspond to the angle between the position of the movable gate 106 of the vehicle 104 and the vehicle body portion 122 associated with the movable gate 106. For example, in case, the angle between a position of a tailgate of the vehicle 104 and a vehicle body portion 122 (e.g., a lower part of a rear chassis) associated with the tailgate is above a particular value, the type of pinch may correspond to “no-pinch” or “low-pinch”. Further, in case the angle is below the particular value, the type of pinch may correspond to “large-pinch”.

It should be noted that the exemplary scenario 500A of FIG. 5A is for exemplary purposes and should not be construed to limit the scope of the disclosure.

FIG. 5B is a block diagram that illustrates exemplary scenario for deployment of the machine learning model embedded into a tail gate control unit, in accordance with another embodiment of the disclosure. FIG. 5B is explained in conjunction with elements from FIG. 1, FIG. 2, FIG. 3, FIG. 4, and FIG. 5A. With reference to FIG. 5B, there is shown an exemplary scenario 500B for the machine learning model based pinch detection from the time-series data 120A of the motor 110 associated with the vehicle movable gate (e.g., the movable gate 106). The exemplary scenario 500B includes a motor 502B, gate operation 504B, a motor current/RPM measurement and processing equipment 506B, a vehicle ECU 508B, and the trained ML model 518A. The vehicle ECU 508B may acquire other sensor data 510B and lifecycle data 512B.

The control circuitry 202 of the electronic device 102 may be coupled with the motor 502B and configured to control the operation associated with the movable gate 106 of the vehicle 104. The motor 502B may be configured to control the operation of the movable gate 106 of the vehicle 104, based on instructions from the control circuitry 202. As shown in FIG. 5B, the GCU 306 may be provided to control the movable gate operation 504B. The movable gate operation or gate operation 504B may be an event occurring during the control of the operation of the motor 502B. The GCU 306 may include suitable logic, control circuitry, interfaces, and/or code that may be configured to acquire the time-series data 120A associated with the operation of the motor 110. The GCU 306 may be communicatively coupled with the vehicle 104 and the motor 110 for control of the gate operation 504B.

In the gate operation 504B, the GCU 306 may determine the statistical features associated with the acquired time-series data 120A, for the control of the gate operation 504B. The GCU 306 may acquire the sensor data 120B associated with the set of sensors 108 and may apply the ML model 116 on the acquired time-series data 120A and the sensor data 120B. The ML model 116 may be trained based on the determined statistical features. The GCU 306 may determine the type of pinch corresponding to the movable gate 106 of the vehicle 104, based on the application of the ML model 116 for the control of the gate operation 504B. The GCU 306 may control the operation of the motor 110 based on the determined type of pinch.

In an example, the motor current or RPM measuring and processing equipment 506B is provided, which may be the data processing equipment 510A to measure and process the time-series data 120A. The motor current or RPM measuring and processing equipment 506B may measure and process the data related with the current associated with the motor 110, or process the data related with the rotation speed associated with the motor 110. It may be appreciated that the time-series data 120A may include at least one of the current associated with the motor 110 (the motor current data), or the rotation speed associated with the motor 110. For example, the motor current data may be the time-series data 120A through each stroke of the tailgate. The motor current data may not be directly fed to any artificial intelligence network, as each stroke of the tailgate may have the plurality of datapoints and length of the data may vary during each stroke of the tailgate, depending upon the temperature sensor data 504A, the vehicle orientation data 506A, and the battery voltage data 508A. The motor current or RPM measuring and processing equipment 506B may measure and process the sensor data 120B acquired from the set of sensors 108.

In one example, the trained ML model 518A may be applied on the acquired time-series data 120A and the sensor data 120B. The trained ML model 518A may correspond to the CNN model, which may be trained based on the determined statistical features. Based on the application of the trained ML model 518A, the type of pinch corresponding to the movable gate 106 of the vehicle 104 may be determined, and the operation of the motor 502B may be controlled based on the determined type of pinch.

In another example, a training dataset associated with the acquired time-series data 120A and the sensor data 120B may be extracted from the vehicle ECU 508B of the vehicle 104. The vehicle ECU 508B may include other sensors data 510B and lifecycle data 512B. The other sensors data 510B may be the data obtained different sensors, like the speed sensor, the current sensor, the voltage sensor, or any other sensor. For example, the speed sensor detects the rotation speed associated with the motor 110. The speed sensor may be any type of speed sensor appropriate for monitoring the rotation speed of the motor 110, such as an encoder, Hall effect sensor, or other type of sensor. Further, the speed sensor may send an output to the motor regulator to control the rotation speed of the motor 110. The current sensor may measure the current associated with the motor 110. The voltage sensor may measure the voltage across the motor 110 and send this information to the motor regulator as well. The lifecycle data 512B may be the data associated with the operating life of the vehicle or vehicle components. The lifecycle data 512B further may be the data associated with the operating life of the motor 502B of the vehicle 104.

In an example, the trained ML model 518A may play the central role in efficiently detecting the pinch condition and determining pinch condition type, taking into account the other sensors data 510B and the lifecycle data 512B embedded into the vehicle ECU 508B. In contrast to the traditional pinch detection models, the disclosed pinch condition type determination process, based on the application of the ML model 116 on the other sensors data 510B and the lifecycle data 512B, may lead to effective classification of the unwanted pinch and typical resistance due to the object from the vehicle seals and stoppers, the reduced false detection rate, the enhanced ability of the electronic device 102 to detect other types of pinch condition due to seals, stoppers, lock mechanism and kinematics of the tailgate, and reduced continuous need to set the reference values for the new vehicle model and vehicle trims.

It should be noted that the exemplary scenario 500B of FIG. 5B is for exemplary purposes and should not be construed to limit the scope of the disclosure.

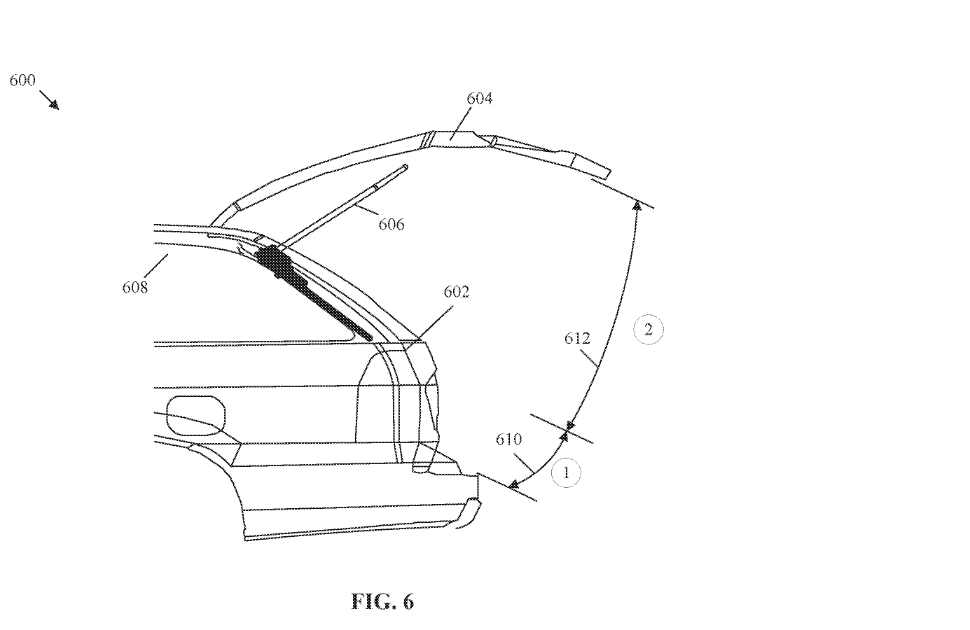

FIG. 6 is a block diagram that illustrates an exemplary scenario of adjustment of operational speed of a motor of a vehicle movable door of a vehicle and a pinch force associated with a vehicle body of the vehicle, in accordance with a first embodiment of the disclosure. FIG. 6 is explained in conjunction with elements from FIG. 1, FIG. 2, FIG. 3, FIG. 4, FIG. 5A, and FIG. 5B. With reference to FIG. 6, there is shown an exemplary scenario 600 for the ML model 116 based pinch detection from the time-series data 120A of the motor 110 associated with the vehicle movable gate (e.g., the movable gate 106). The scenario 600 illustrates an adjustment of the operational speed of the motor 110 of the movable gate 106 of the vehicle 104 and a pinch force associated with the vehicle body portion 122 of the vehicle 104.

The exemplary scenario 600 includes a vehicle body portion 602, a gate 604, a fixation joint 606, and a window 608. The vehicle body portion 602 may be positioned to provide a space for accommodating the gate 604, the fixation joint 606, and the window 608. The gate 604 may be the movable gate 106 of the vehicle 104. It may be appreciated that the gate 604 may correspond to at least one of the door of the vehicle 104, the tailgate of the vehicle 104, the liftgate of a vehicle 104, the window of the vehicle 104, the bonnet of the vehicle 104, the sunroof of the vehicle 104, or the trunk of the vehicle 104. The fixation joint 606 may be positioned adjacent to the gate 604, and mounted on the window 608. The type of pinch may be determined corresponding to the gate 604 of the vehicle 104, based on the application of the ML model 116.

In an example, the pinch detection may be achieved by calculating a pinch limit angle corresponding to a pinch detected over an area of the vehicle 104. For example, a first angle 610 may be determined. The first angle 610 may correspond to an angle lesser than a first pinch-limit angle formed over an area of the gate 604 of the vehicle 104. Herein, the first pinch-limit angle may be a smaller angle (e.g., an angle “X”, such as, 20 degrees) due to a possibility of finger pinching in the area of the vehicle 104. Alternatively and/or additionally, a second angle 612 may be determined. The second angle 612 may correspond to an angle greater than a second pinch-limit angle formed over the area of the gate 604 of the vehicle 104. Herein, the second pinch-limit angle may be larger angle (e.g., an angle “2*X”, such as, 40 degrees) due to the possibility of the arrangement of larger objects pinched over the gate 604 or the area of the gate 604.

It should be noted that the exemplary scenario 600 of FIG. 6 is for exemplary purposes and should not be construed to limit the scope of the disclosure.

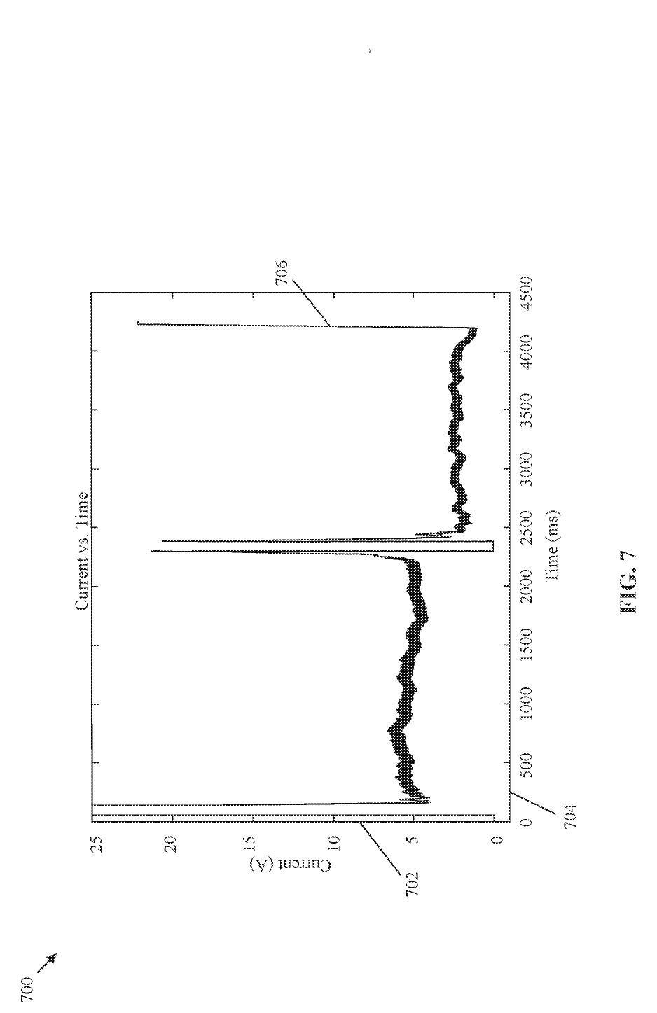

FIG. 7 is a diagram that illustrates graphical representation of motor current data sample, in accordance with one embodiment of the disclosure, in accordance with a second embodiment of the disclosure. FIG. 7 is explained in conjunction with elements from FIG. 1, FIG. 2, FIG. 3, FIG. 4, FIG. 5A, FIG. 5B, FIG. 6. With reference to FIG. 7, there is shown an exemplary scenario 700. The exemplary scenario 700 may include a current axis 702. The exemplary scenario 700 further illustrates a time axis 704. The exemplary scenario 700 further illustrates a feature value curve 706. A set of operations associated the scenario 700 is described herein.

In the scenario 700 of FIG. 7, the current axis 702 in a graph of current recorded versus time for the motor current data sample is shown. Since the current may be the electrical activity that may occur each time during each stroke of the movable gate 106 of the vehicle 104, the amplitude of the current axis may be a calculated as a periodic current for each stroke of the movable gate 106 of the vehicle 104. The current may be represented in Amperes (A) along the current axis 702 of the motor current data sample, and the time may be represented in milliseconds along the time axis 704 of the motor current data sample.

It may be noted that the resultant extracted feature value corresponding to the feature value curve 706 may have the highest coefficient value, at the current value of “20 Amperes” recorded at a time interval of “4200 milliseconds”. With reference to FIG. 7, the amplitudes of the current wave at the current axis 702 may be lesser than “30” Amperes. For example, a peak the current wave at the current axis 702 may be approximately “25 Amperes”. Similarly, the time period or time interval at which current calculated each time may be “4500 milliseconds” as the highest coefficient value along the time axis 704.

It should be noted that the exemplary scenario 700 of FIG. 7 is for exemplary purposes and should not be construed to limit the scope of the disclosure.

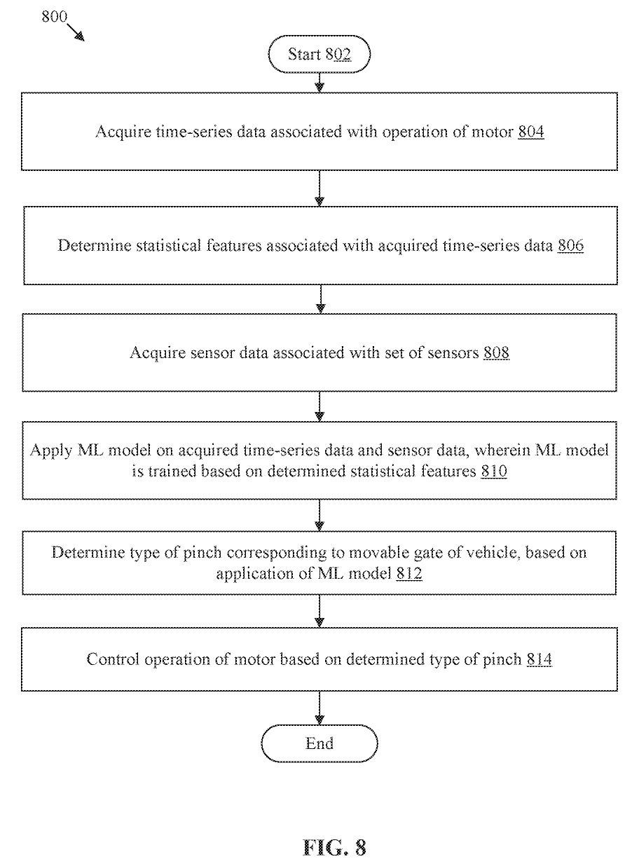

FIG. 8 is a flowchart that illustrates exemplary operations of a method for machine learning model based pinch detection from time-series data of the motor associated with the vehicle movable gate, in accordance with one embodiment of the disclosure. FIG. 8 is described in conjunction with FIG. 1, FIG. 2, FIG. 3, FIG. 4, FIG. 5A, FIG. 5B, FIG. 6 and FIG. 7. With reference to FIG. 8, there is shown a flowchart 800. The flowchart 800 includes operations from 802 to 814 that may be implemented, for example, by the control circuitry 202 of the electronic device 102 of FIG. 2. The operations of the flowchart 800 may start at 802 and proceed to 804.

At 804, the time-series data 120A, that may be associated with the operation of the motor 110, may be acquired. The acquired time-series data 120A may be compared with the first threshold range associated with the operation of the motor 110 to determine the type of pinch. In an embodiment, the control circuitry 202 may be configured to acquire the time-series data 120A associated with the operation of the motor 110. Further, the time-series data 120A may be at least one of the current associated with the motor 110 or the rotation speed associated with the motor 110. Details related to the acquisition of the time-series data 120A are provided, for example, in FIG. 4 (at 402).

At 806, the statistical features associated with the acquired time-series data 120A may be determined. In an embodiment, the control circuitry 202 may be configured to determine the statistical features associated with the acquired time-series data 120A. Further, the statistical features associated with the acquired time-series data 120A may include at least one of the mean, the standard deviation, the skewness, the kurtosis, the variance, the Fast Fourier Transform (FFT) coefficients, or the data length associated with the acquired time-series data 120A. Details related to the determination of the statistical features associated with the acquired time-series data 120A are provided, for example, in FIG. 4 (at 404).

At 808, the sensor data 120B associated with the set of sensors 108 of the vehicle 104 may be acquired. In an embodiment, the control circuitry 202 may be configured to acquire the sensor data 120B associated with the set of sensors 108. Further, the sensor data 120B may include at least one of the orientation of the vehicle 104, the temperature of the vehicle 104, or the battery voltage of the vehicle 104. Details related to the acquisition of the sensor data 120B are provided, for example, in FIG. 4 (at 406).

At 810, the ML model 116 on the acquired time-series data 120A and the sensor data 120B may be applied. The ML model 116 may be trained based on the determined statistical features. In an embodiment, the control circuitry 202 may be configured to apply the ML model 116 on the acquired time-series data 120A and the sensor data 120B. Further, the ML model 116 may correspond to the CNN model. Details related to the application of the ML model 116 on the acquired time-series data 120A and the sensor data 120B are provided, for example, in FIG. 4 (at 408).

At 812, the type of pinch corresponding to the movable gate 106 of the vehicle 104 may be determined, based on the application of the ML model 116. The type of pinch may correspond to an angle between the position of the movable gate 106 and the vehicle body portion 122. In an embodiment, the control circuitry 202 may be configured to determine the type of pinch corresponding to the movable gate 106 of the vehicle 104, based on the application of the ML model 116. In an embodiment, the type of pinch may be determined based on the comparison of the acquired time-series data 120A with the first threshold range. Further, the type of pinch may correspond to a “no- pinch” based on the acquired time-series data 402A being below the first threshold range. Further, the type of pinch may correspond to a “small-pinch” based on the acquired time-series data 402A being within the first threshold range. Further, the type of pinch may correspond to a “large-pinch” based on the acquired time-series data 402A being above the first threshold range. In an embodiment, the type of pinch may be determined based on the comparison of the acquired time-series data 120A with the second threshold range. Further, the type of pinch may correspond to a “no-pinch” based on the acquired time-series data 402A being below the second threshold range. Further, the type of pinch may correspond to a “small-pinch” based on the acquired time-series data being within the second threshold range. Further, the type of pinch may correspond to a “large-pinch” based on the acquired time-series data being above the second threshold range. Details related to the determination of the type of pinch corresponding to the movable gate 106 of the vehicle 104 are provided, for example, in FIG. 4 (at 410).

At 814, the operation of the motor 110 may be controlled based on the determined type of pinch. In an embodiment, the control circuitry 202 may be configured to control the operation of the motor 110, based on the determined type of pinch. Details related to the control of the operation of the motor 110 are provided, for example, in FIG. 4 (at 412). Control may pass to end.

Although the flowchart 800 is illustrated as discrete operations, such as, 804, 806, 808, 810, 812, and 814 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the control circuitry 202). The instructions may cause the machine and/or computer (for example, the electronic device 102) to perform operations that may include acquiring time-series data (e.g., the time-series data 120A) associated with operation of a motor (e.g., the motor 110) associated with a movable gate (e.g., the movable gate 106) of a vehicle (e.g., the vehicle 104). The operations may further include determining the statistical features associated with the acquired time-series data 120A. The operations may further include acquiring sensor data (e.g., the sensor data 120B) associated with a set of sensors (e.g., the set of sensors 108) of the vehicle 104. The operations may further include applying a machine learning (ML) model (e.g., the ML model 116) on the acquired time-series data 120A and the sensor data 120B. The ML model 116 may be trained based on the determined statistical features. The operations may further include determining the type of pinch corresponding to the movable gate 106 of the vehicle 104, based on the application of the ML model 116. The operations may further include controlling the operation of the motor 110 based on the determined type of pinch.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the control circuitry 202 of the electronic device 102). The instructions may cause the machine and/or computer (for example, the gate control unit (GCU) 306 of the vehicle 104) to perform operations that include acquiring the time-series data 120A associated with operation of the motor 110. The operations may further include determining the statistical features associated with the acquired time-series data 120A. The operations may further include acquiring the sensor data 120B associated with the set of sensors 108 of the vehicle 104. The operations may further include applying the machine learning (ML) model 116 on the acquired time-series data 120A and the sensor data 120B. The ML model 116 may be trained based on the determined statistical features. The operations may further include determining the type of pinch corresponding to the movable gate 106 of the vehicle 104, based on the application of the ML model 116. The operations may further include controlling the operation of the motor 110 based on the determined type of pinch.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. A vehicle, comprising:
a movable gate of the vehicle;
a motor configured to control an operation of the movable gate of the vehicle;
a set of sensors associated with the vehicle; and
control circuitry coupled to the motor, the control circuitry configured to:
acquire time-series data associated with an operation of the motor;
determine statistical features associated with the acquired time-series data;
acquire sensor data associated with the set of sensors;
apply a machine learning (ML) model on the acquired time-series data and the sensor data, wherein
the ML model is trained based on the determined statistical features;
determine a type of pinch corresponding to the movable gate of the vehicle, based on the application of the ML model; and
control the operation of the motor based on the determined type of pinch.

2. The vehicle according to claim 1, wherein the movable gate corresponds to at least one of:
a door of the vehicle,
a tailgate of the vehicle,
a liftgate of the vehicle,
a window of the vehicle,
a bonnet of the vehicle,
a sunroof of the vehicle, or
a trunk of the vehicle.

3. The vehicle according to claim 1, wherein the control circuitry is further configured to:
compare the acquired time-series data with a first threshold range; and
determine the type of pinch based on the comparison of the acquired time-series data with the first threshold range.

4. The vehicle according to claim 3, wherein
the type of pinch corresponds to a no-type of pinch based on the acquired time-series data being below the first threshold range,
the type of pinch corresponds to a small-type of pinch based on the acquired time-series data being within the first threshold range, or
the type of pinch corresponds to a large-type of pinch based on the acquired time-series data being above the first threshold range.

5. The vehicle according to claim 1, wherein the control circuitry is further configured to:
compare the determined statistical features associated with the acquired time-series data with a second threshold range; and
determine the type of pinch based on the comparison of the determined statistical features with the second threshold range.

6. The vehicle according to claim 5, wherein
the type of pinch corresponds to a no-type of pinch based on the acquired time-series data being below the second threshold range,
the type of pinch corresponds to a small-type of pinch based on the acquired time-series data being within the second threshold range, or
the type of pinch corresponds to a large-type of pinch based on the acquired time-series data being above the second threshold range.

7. The vehicle according to claim 1, wherein
the acquired sensor data includes at least one of an orientation of the vehicle, a temperature of the vehicle, or a battery voltage of the vehicle, and
the acquired time-series data includes at least one of a current associated with the motor or a rotation speed associated with the motor.

8. The vehicle according to claim 1, wherein the ML model corresponds to a Convolutional Neural Network (CNN) model.

9. The vehicle according to claim 1, wherein the determined statistical features include at least one of:
a mean,
a standard deviation,
a skewness,
a kurtosis,
a variance,
Fast Fourier Transform (FFT) coefficients, or
a data length.

10. The vehicle according to claim 1, wherein the type of pinch corresponds to an angle between a position of the movable gate and a vehicle body portion associated with the movable gate.

11. An electronic device, comprising:
control circuitry coupled to a motor configured to control an operation associated with a movable gate of a vehicle, the control circuitry configured to:
acquire time-series data associated with an operation of the motor;
determine statistical features associated with the acquired time-series data;
acquire sensor data associated with a set of sensors of the vehicle;
apply a machine learning (ML) model on the acquired time-series data and the sensor data, wherein
the ML model is trained based on the determined statistical features;
determine a type of pinch corresponding to the movable gate of the vehicle, based on the application of the ML model; and
control the operation of the motor based on the determined type of pinch.

12. The electronic device according to claim 11, wherein the movable gate corresponds to at least one of:
a door of the vehicle,
a tailgate of the vehicle,
a liftgate of the vehicle,
a window of the vehicle,
a bonnet of the vehicle,
a sunroof of the vehicle, or
a trunk of the vehicle.

13. The electronic device according to claim 11, wherein the control circuitry is further configured to:
compare the acquired time-series data with a first threshold range; and
determine the type of pinch based on the comparison of the acquired time-series data with the first threshold range.

14. The electronic device according to claim 13, wherein
the type of pinch corresponds to a no-type of pinch based on the acquired time-series data being below the first threshold range,
the type of pinch corresponds to a small-type of pinch based on the acquired time-series data being within the first threshold range, or
the type of pinch corresponds to a large-type of pinch based on the acquired time-series data being above the first threshold range.

15. The electronic device according to claim 11, wherein the control circuitry is further configured to:
compare the determined statistical features associated with the acquired time-series data with a second threshold range; and
determine the type of pinch based on the comparison of the determined statistical features with the second threshold range.

16. The electronic device according to claim 15, wherein
the type of pinch corresponds to a no-type of pinch based on the acquired time-series data being below the second threshold range,
the type of pinch corresponds to a small-type of pinch based on the acquired time-series data being within the second threshold range, or
the type of pinch corresponds to a large-type of pinch based on the acquired time-series data being above the second threshold range.

17. The electronic device according to claim 11, wherein
the acquired sensor data includes at least one of an orientation of the vehicle, a temperature of the vehicle, or a battery voltage of the vehicle, and
the acquired time-series data includes at least one of a current associated with the motor or a rotation speed associated with the motor.

18. The electronic device according to claim 11, wherein the determined statistical features include at least one of:
a mean,
a standard deviation,
a skewness,
a kurtosis,
a variance,
Fast Fourier Transform (FFT) coefficients, or
a data length.

19. The electronic device according to claim 11, wherein the type of pinch corresponds to an angle between a position of the movable gate and a vehicle body portion associated with the movable gate.

20. A method, comprising:
in a vehicle including a motor configured to control an operation associated with a movable gate of the vehicle:
acquiring time-series data associated with an operation of the motor;
determining statistical features associated with the acquired time-series data;
acquiring sensor data associated with a set of sensors of the vehicle;
applying a machine learning (ML) model on the acquired time-series data and the sensor data, wherein
the ML model is trained based on the determined statistical features;
determining a type of pinch corresponding to the movable gate of the vehicle, based on the application of the ML model; and
controlling the operation of the motor based on determined type of pinch.
